(19) United States
(12) Patent Application Publication
(10) Pub. No.: US 2003/0028444 A1
(43) Pub. Date: Feb. 6, 2003

(54) Method and system for conducting online auctions of copper concentrates

(76) Inventors: Phillip Steven Kubicek, Mandeville, LA (US); James Collin Guidry, Metairie, LA (US); Michael Taylor Charbonnet, Metairie, LA (US)

Correspondence Address: Keith M. Landry, Jones Walker, 50th Floor, 201 St. Charles Avenue, New Orleans, LA, 70170-5100, US

(21) Appl. No.: 10/202,770

(22) Filed: Jul. 25, 2002

Related U.S. Application Data
(60) Provisional application No. 60/309,086, filed on Jul. 31, 2001.

(51) Int. Cl. G06F 17/60

(52) U.S. Cl. 705/26; 705/37

(57) ABSTRACT

A method and system for conducting online auctions, and in particular, a method and system for conduction online auctions of copper concentrates in fixed amounts according to a bid term. The participants in the auction are granted access to a secure area of a website, and enter bids over a communications network on parcels of copper concentrates. The auction is conducted in two stages, namely, an opening round and a closing round. The winner of the auction is the participant that submits the lowest confirmed bid for the bid term to end the closing round. The auction allows for the auction participants to enter bids either manually or through the use of an automated bid feature. The automated bid feature entering a bid on behalf of an auction participant if the minimum bid threshold specified by the participant is lower than the previous confirmed bid by at least the minimum bid increment.

### CROSS-REFERENCE TO RELATED APPLICATION

This application claims the benefit of U.S. Provisional Patent Application No. 60/309,086, filed Jul. 31, 2001. The subject matter of that application is incorporated by this reference.

### BACKGROUND OF THE INVENTION

1. Field of the Invention

The present invention relates to a method and system for conducting online auctions, and in particular, to a method and system for conducting online auctions of copper concentrates in fixed amounts. The participants in the auction will be granted access to a secure area of a website, and will enter bids on parcels of copper concentrates from the website's secure area. The bidding will be based on a combined smelting and refining charge per pound of payable copper, or, alternatively, on a separate smelting charge per dry metric ton (DMT) of concentrates and a refining charge per pound of payable copper. The auction will be conducted in two stages, namely, an opening round and a closing round. The auction also allows for auction participants to enter bids either manually or through the use of an automated bid feature.

2. Description of the Related Art

The use of the Internet to conduct auctions is well-established for a variety of goods and services. The use of the Internet to conduct auctions among auction participants is beneficial because it allows for the instant communication of bidding information among remote auction participants resulting in more efficient results for the auction holder. The auction method and system of the present invention benefits from the advantages of the Internet applicable to most online auction websites, but also is particularly designed for use for the online auction of copper concentrates and contains various features that are uniquely suited to copper concentrate auctions and sales transactions. It can be appreciated, however, that the online auction method and system of the present invention could be used to auction other products or services including, without limitation, other metals or commodities.

### SUMMARY OF THE INVENTION

The present invention is a method and system for using the Internet to conduct online auctions of copper concentrates among prequalified potential customers. The customers can participate in the auction electronically from remote terminals and systems by accessing the website at “www.copperconcentrate.com”. Before participating in an auction, each customer must be prequalified by the auction host. A customer is prequalified to participate in an auction based on certain information about the customer that the customer submits over the website intended to limit the auction participants to entities regularly engaged in the buying, selling, trading or smelting of copper concentrates in commercial quantities. The auction website will have a “public area” that is accessible by any visitor to the website and a “secure area” that only prequalified auction participants may access through the use of a user ID and password obtained from the auction host. The auction host may or may not be the actual producer of the copper concentrates being auctioned. From the secure area of the website, auction participants will bid on one or more parcels of copper concentrate in an auction conducted at a prescheduled date and time. The bidding is conducted either on the basis of “combined terms”, or, alternatively, on the basis of “separated terms”. If the auction is conducted on the basis of combined terms, the winner of the auction shall be the bidder submitting the lowest bid amount for the “combined smelting and refining charge per pound of payable copper” for the parcel of copper concentrate being auctioned. The combined smelting and refining charge per pound of payable copper term is a copper concentrate sales transaction term that is generally known by sellers and buyers of copper concentrates in the industry. Alternatively, if the auction is conducted on the basis of separated terms, the bidders will submit bids for the first term, “the smelting charge per DMT of concentrates”, and the second term, “the refining charge per pound of payable copper”, will be calculated automatically based on the bid for the first term (in one embodiment, calculated as 1/1000 of the first term). The winner of the auction shall be the bidder submitting the lowest bid amount for the first term and, because the second term is calculated directly from the first term, the lowest bid amount for the second term. Both the first term and the second term will collectively constitute the bid being placed by the auction participant. The smelting charge per DMT of concentrates and the refining charge per pound of payable copper are copper concentrate sales transaction terms that are generally known by sellers and buyers of copper concentrates in the industry.

The auction is conducted in two stages, an opening round and a closing round. During the opening round, auction participants can bid as much and as often as desired during a predefined period of time. Upon completion of the opening round, the closing round will commence immediately. To participate in the closing round, an auction participant may only bid if the auction participant entered a confirmed bid during the opening round. The closing round will remain open until the passage of a specified period of time, typically five to fifteen minutes, during which no new, qualifying bid is confirmed. For a bid to qualify, a bid must be lower than the previous confirmed bid by a predetermined minimum bid increment or some multiple of the minimum bid increment. For bidding based on combined terms, the minimum bid increment is typically about 0.05 cents. For bidding based on separated terms, the minimum bid increment for the smelting charge term is typically about 0.25 dollars and for the refining charge term is about 0.00025 dollars. If an auction participant's bid is the lowest confirmed bid at the end of a closing round period, the auction participant is obligated to complete the sale transaction for the copper concentrate parcel auctioned.

During both the opening round and the closing round, the auction participant has the opportunity to submit bids either manually or through the use of an automated bid feature. The automated bid feature will allow auction participants to have bids automatically entered by the system on their behalf down to a specified minimum bid threshold.

These and other objects and features of the present invention will become apparent from the following Detailed Description and the accompanying drawings.

### BRIEF DESCRIPTION OF THE DRAWINGS

For a further understanding of the features and advantages of the present invention, reference should be made to the following Detailed Description taken in conjunction with the accompanying drawing in which like parts are given like reference numerals and wherein:

FIG. 1 is a screen capture image of the auction announcement page accessible from the public area of the present invention in which the bidding is based on combined terms.

FIG. 2 shows how the auction announcement page could be reconfigured for bidding based on separated terms.

FIG. 3 is a screen capture image of the current status page of the secure area of the present invention in which the bidding is based on combined terms.

FIG. 4 shows how the current status page could be reconfigured for bidding based on separated terms.

FIG. 5 is a screen capture image of the automated bid entry page for the automated bid feature of the present invention in which the bidding is based on combined terms.

FIG. 6 shows how the automated bid entry page could be reconfigured for bidding based on separated terms.

FIG. 7 is a block diagram showing the process of the automated bid feature of the present invention.

FIG. 8 is a set of examples of manual and automated bidding by auction participants in accordance with the present invention.

### DETAILED DESCRIPTION OF THE PREFERRED EMBODIMENT

The website of the present invention is hosted on a server having a database for storing information relating to the auction and the bids received during the auction as further described below. The website can be accessed by customers over the Internet from remote terminals and computer systems by accessing the website at “www.copperconcentrate.com”.

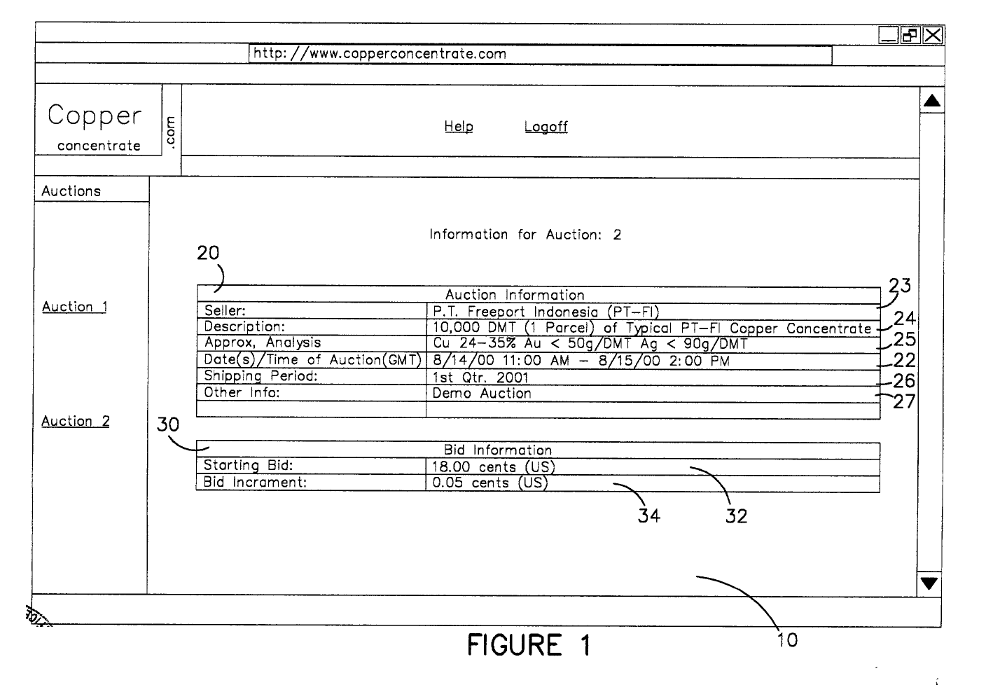

The website consists of a public, unsecured area accessible by all visitors to the website and a secure area that will only be accessible by customers that have been qualified as auction participants by the auction host. As shown in FIG. 1, the public area of the website 10 consists of general postings relating to upcoming scheduled auctions. The public area 10 also includes links to enable the visitor to review the contractual terms and conditions for participating in the auctions and to contact a marketing representative of the auction host. Also, the public area 10 includes links to enable the visitor to obtain additional information about the auction host and its affiliates and to access additional links of potential interest to the visitor.

The information relating to upcoming auctions is set forth in an auction information table 20. The auction information table 20 displays information relating to the scheduled date and time of the auction 22 as well as other information relating to certain commercial terms and conditions applicable to a copper concentrate sales transaction entered into as a result of the online auction. Although the auction information table 20 is designed specifically for the auction of copper concentrates, it can be appreciated that it could be used to auction other products or services, including, without limitation, other metals and commodities.

For purposes of performing the auction, most of the commercial terms and conditions relating to the copper concentrates included in each upcoming auction are preset and displayed in the auction information table 20 so that the auction can be held with respect to bidding on the basis of “combined terms” or, alternatively, on the basis of “separated terms”. The commercial terms applicable to the sales transaction that are preset and displayed in the auction information table 20 include a description of the seller of the copper concentrate parcel 23, the amount of the copper concentrate parcel expressed typically in DMT's 24, the approximate analysis of the chemical composition of the copper concentrate parcel 25 and the projected shipping period for the copper concentrate parcel 26. Other information and commercial terms applicable to the sales transaction can be displayed as desired by the auction host in additional rows 27 or can be agreed to by each auction participant and the auction host pursuant to contractual agreements entered into prior to the commencement of the auction.

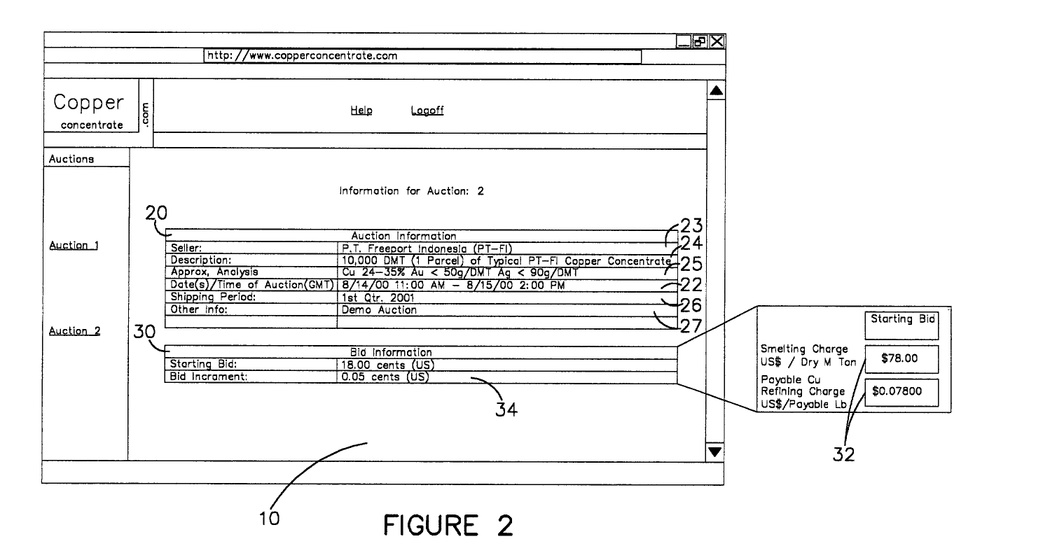

The public area 10 of the website also includes a bid information table 30. As shown in FIG. 1, the bid information table is configured for bidding on the basis of combined terms. In FIG. 2, the bid information table may be reconfigured as shown for bidding on the basis of separated terms. If the auction is conducted on the basis of combined terms, the combined terms are well-known in the industry and referred to as the “combined smelting and refining charge per pound of payable copper”. If the auction is conducted on the basis of separated terms, the bidding is based on a first term, referred to as “the smelting charge per DMT of concentrates”, and the second term, “the refining charge per pound of payable copper”, is calculated automatically based on the bid for the first term. In the preferred embodiment, the second term, the refining charge term, is automatically calculated as 1/1000 of the first term, the smelting charge term. Thus, the amount of dollars bid for the smelting charge term will equate to the number of tenths of a cent for the refining charge term. For example, if the bid is $74.00 for the smelting charge term, the refining charge term is automatically calculated to equal $0.07400. Alternatively, the refining charge term could be calculated based on the smelting charge term using another formula as set by the auction host.

The bid information table 30 includes information relating to the starting minimum bid 32 for the copper concentrate parcel to be auctioned and the minimum bid increment 34. For bidding based on combined terms, a single minimum bid amount for the combined terms and the minimum bid increment are displayed. The minimum bid increment for combined terms bidding is typically about 0.05 cents. For bidding based on separated terms, the minimum bid amount and the minimum bid increment are displayed for the smelting charge term and the refining charge term. Both the smelting charge term and refining charge term collectively will represent the total bid for the purpose of separated terms. The minimum bid increments for separated terms bidding is typically about 0.25 dollars for the smelting charge term and 0.00025 dollars for the refining charge term.

As the auction progresses, all bids entered by auction participants must be entered in multiples of the minimum bid increment. Once the minimum bid increment is set it will apply for the duration of the auction and no bids will be accepted that are not some multiple of the minimum bid increment below the previous confirmed bid.

In order for a visitor of the website to participate in an auction, the visitor must access the secure area of the website 40. The secure area 40 is accessed by the visitor by entering a user ID and a password obtained from the auction host. The auction host will also provide each auction participant with an electronic certificate of qualification to participate in the auction. Before granting the auction participant with access to the secure area 40, the auction host may require that the auction participant enter into contractual agreements such as a concentrate sales agreement setting forth, in greater detail, the terms and conditions that will apply to copper concentrate sales transactions entered into as a result of the online auction of the present invention.

When the auction host announces a scheduled auction to potential auction participants, the auction participants will receive an invitation from the auction host including an addendum to the previously executed concentrate sales agreement. The addendum will specify whether the auction will be conducted on the basis of combined terms or separated terms. The addendum will also specify all of the commercial terms that relate to the parcel of copper concentrate to be auctioned with the exception of either the combined terms or the separated terms, which shall be determined during the auction. Auction participants will typically be required to execute the applicable addendum at least 3 business days prior to the auction.

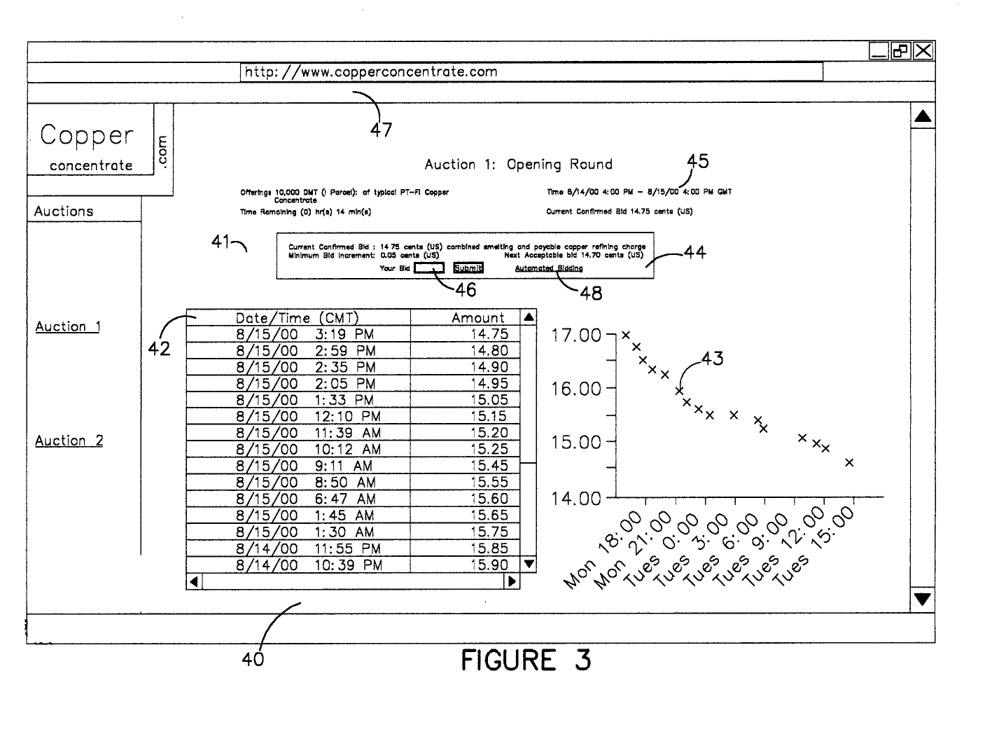

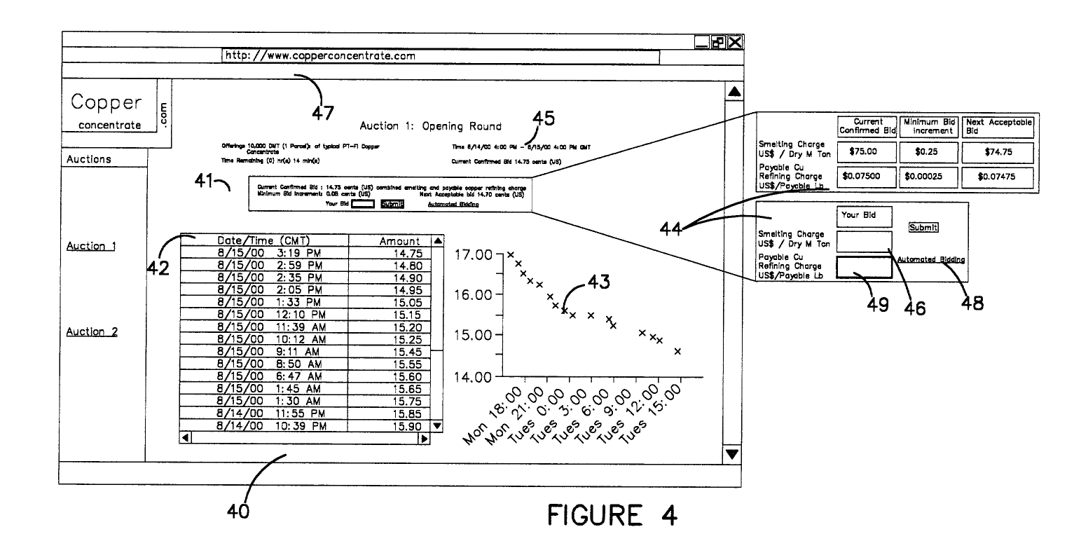

As shown in FIGS. 3 and 4, the secure area 40 displays a current status page 41 which includes an auction status table 42, an auction status graph 43 and a bid entry bar 44. The auction status table 42 lists confirmed bids in descending order by the amount and the time that the bid was confirmed. If a bid was entered by the auction participant viewing the current status page 41, the bids entered by such auction participant will be highlighted in the auction status table 42. The auction status graph 43 provides a graphical representation of the information contained in the auction status table 42. On the vertical axis, the confirmed bid amounts are charted in descending order. On the horizontal axis, the date and times that the bids were confirmed are charted.

The bid entry bar 44 enables the auction participant to submit bids manually through a bid submission link 46. The bid entry bar 44 displays information relating to the current confirmed bid, the minimum bid increment and the next acceptable bid. The next acceptable bid is the current confirmed bid less the minimum bid increment. For combined terms bidding as shown in FIG. 3, a single field is provided for the bid submission link 46 for the auction participant to enter a bid. For separated terms bidding as shown in FIG. 4, a field is provided for the auction participant to enter a bid for the smelting charge term for the bid submission link 46, but a second field 49 is also provided to display the refining charge term which is calculated automatically from the specified smelting charge term. After entering the bid information, the auction participant enters the bid by clicking on a submit button icon.

In order for a bid to be accepted by the system, the bid must be lower than the previous confirmed bid by the amount of the prescribed minimum bid increment or some multiple of the minimum bid increment. If the bid does not satisfy the minimum bid increment, the auction participart submitting the bid will be notified that the bid cannot be accepted. If the submitted bid satisfies the minimum bid increment, a confirmation will be displayed to the auction participant to permit the auction participant to either accept or retract the bid. If the bid is accepted, the bid is officially submitted as a new bid. The bid entry bar 44 also provides a link 48 to enable the auction participant to use the automatic bid feature of the present invention.

For purposes of making the auctions more efficient and enable more auction participants to participate in the auction process, auctions performed in accordance with the present invention will be conducted in two stages. The first stage is referred to as the opening round and the second stage is referred to as the closing round. The opening round is for a fixed period of time and may typically range anywhere from a period of 4 hours to 24 hours depending on the circumstances and the locations of the auction participants. During the opening round of bidding, a clock 45 is displayed on the current status page 41 for convenience and to show auction participants the amount of hours and minutes left in the opening round of bidding. At the expiration of the opening round, the closing round will commence immediately. In order for an auction participant to be able to submit a bid during the closing round, the auction participant must have entered a bid and the bid must have been confirmed during the opening round.

During the closing round, bidding will continue until the expiration of a specified period of time during which there have been no new confirmed bids. Typically, this period of time will be five to fifteen minutes in duration. If a new qualifying bid is confirmed prior to the expiration of the specified bidding period, the clock 45 will be reset and a new bidding period will begin. If the specified bidding period expires and no new bid has been confirmed, then the previous bid confirmed by the system will be the winning bid. A banner will appear notifying the successful auction participant that the auction has been completed and that the auction participant's bid was the lowest confirmed bid. Upon completion of the auction, the bid submission link 46 of the bid entry bar 44 for submitting new bids will be disabled and no new bids can be submitted by the other auction participants.

In order for an auction participant to receive constantly updated bidding information on the current status page 41, the auction participant must refresh the current status page 41 regularly in order to view the latest bids and update the clock 45. The current status page 41 may be refreshed by the auction participant by clicking on the “Refresh” icon or text on the toolbar 47.

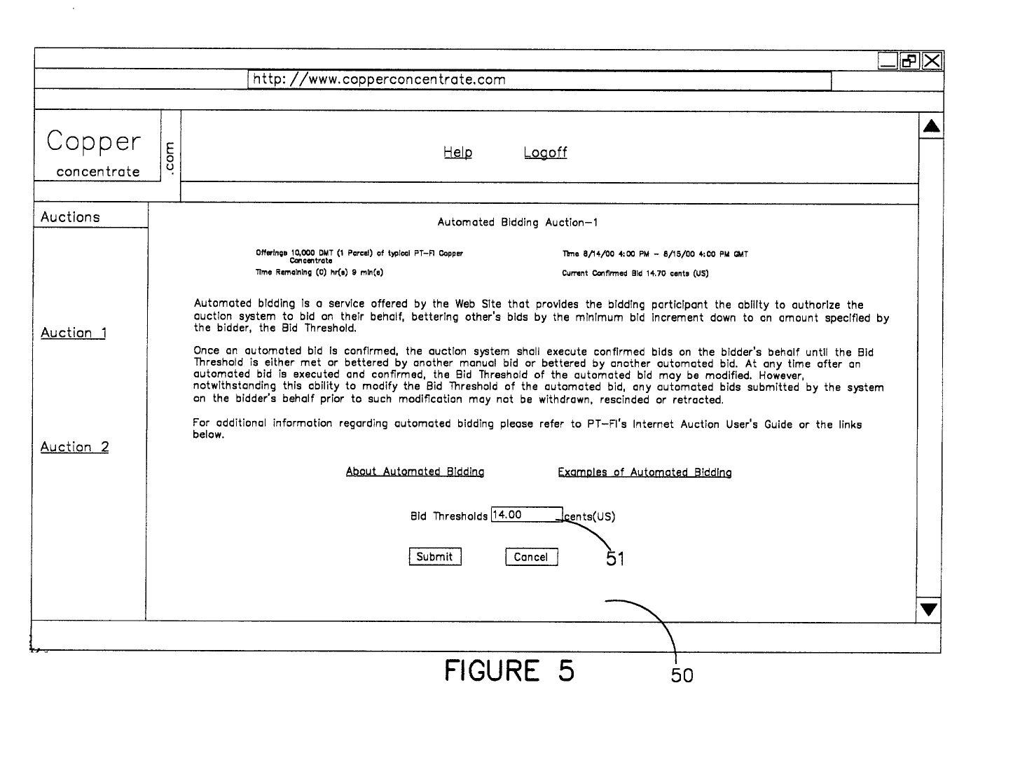

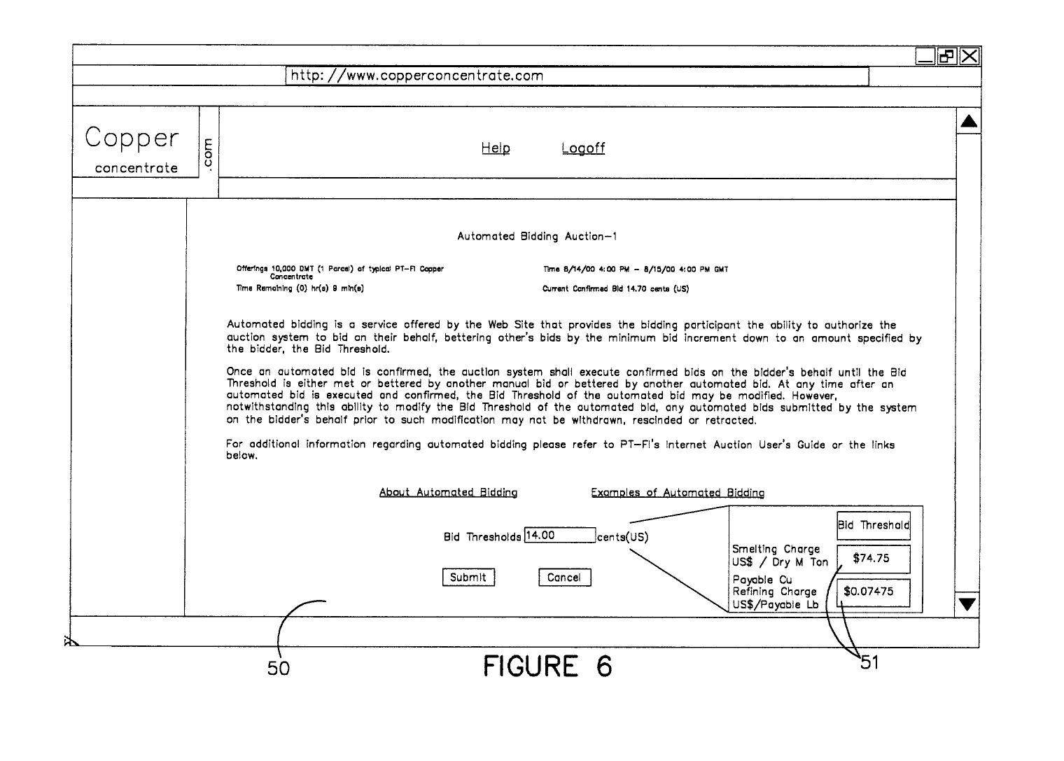

During the opening round and the closing round, the auction participant will have the option of submitting bids either manually or by using the automated bid feature of the present invention. If the auction participant desires to use the automated bid feature, the auction participant shall click on the automated bid link 48 located on the bid entry bar 44. The auction participant will be prompted by an automated bid page 50 shown in FIGS. 5 and 6. FIG. 5 shows the automated bid page 50 as configured for bidding based on combined terms, and FIG. 6 shows the automated bid page 50 as it may be reconfigured for bidding based on separated terms. In the automated bid threshold link 51, the auction participant will enter a minimum bid threshold to be used and stored by the automated bid feature. For bidding based on combined terms, the auction participant enters the single minimum bid threshold for the combined terms. For bidding based on separated terms, the auction participant enters the minimum bid threshold for the smelting charge term and the corresponding minimum bid threshold is automatically calculated for the refining charge term. After the auction participant has completed entering the minimum bid threshold information, the auction participant enters the minimum bid threshold information in the automated bid feature by clicking on a submit button icon. The auction participant can also cancel the entry of the minimum bid threshold information by clicking on a cancel button icon.

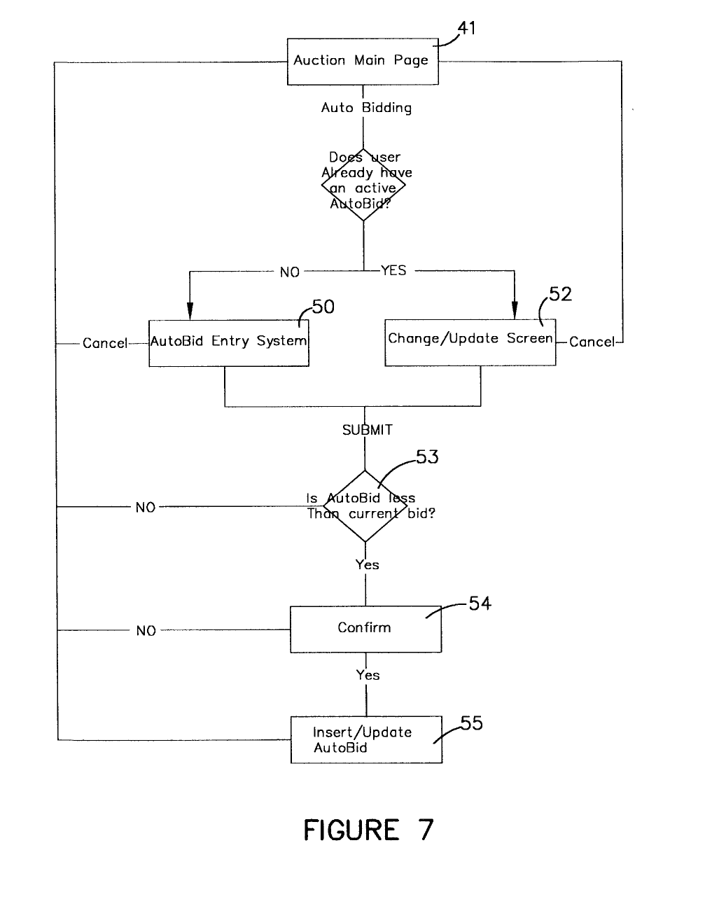

The process of the automated bid feature of the present invention is shown in greater detail in FIG. 7. The automated bid feature process is the same whether the bidding is based on combined terms or on separated terms. If an auction participant has already entered a minimum bid threshold, when the current status page 41 is updated with a new confirmed bid 52 the automated bid feature will compare the amount of the new confirmed bid to the auction participant's minimum bid threshold. If the auction participant's minimum bid threshold is lower than the previous confirmed bid by at least the minimum bid increment 53, the automated bid feature will execute a new bid on behalf of the auction participant. If the bidding is based on combined terms, the bid will be a new bid for the combined terms. If the bidding is based on separated terms, the bid will be a new bid for the smelting charge term and the refining charge term will be automatically calculated based on the bid for the smelting charge term. The system will then confirm such bid 54 and the current status page 41 will be updated to include such confirmed bid 55. The new bid will become the new confirmed bid 55 displayed in both the auction status table 42 and the auction status graph 43 on the current status page 41. If the auction participant's minimum bid threshold is not lower than the previous confirmed bid by an amount equal to at least the minimum bid increment 53, the automated bid feature will not execute a new bid on behalf of the auction participant.

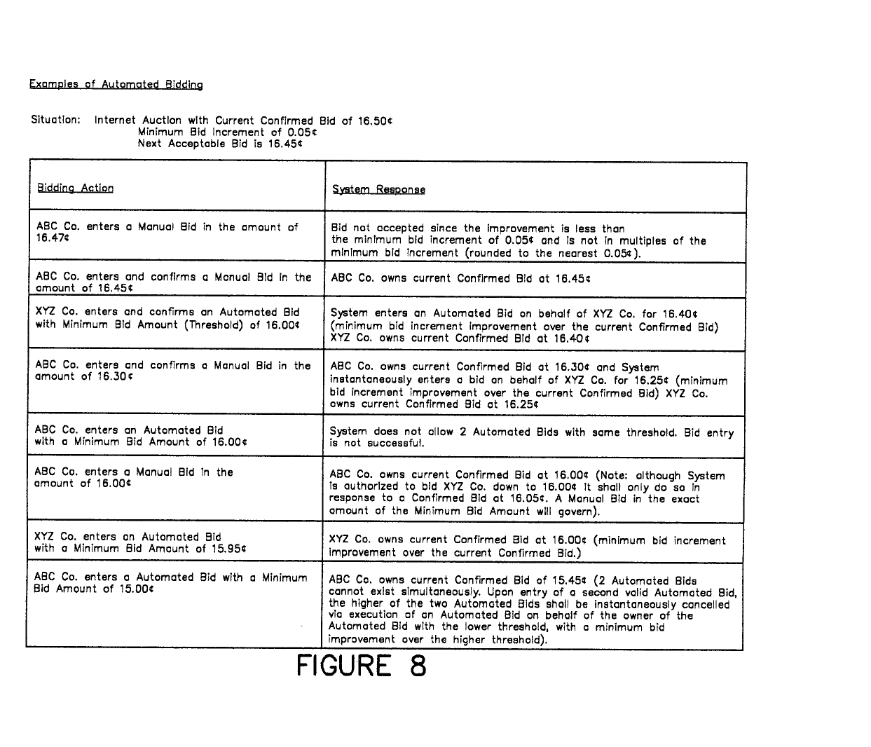

In those situations where two automated bids have the same minimum bid threshold, the auction participant that has an automated bid with a minimum bid threshold of the same amount as a previously entered automated bid will receive an error message and the automated bid will not be entered. If two automated bids are entered with different minimum bid thresholds, an automated bid will be executed for the auction participant having the lower minimum bid threshold in an amount that is lower than the minimum bid threshold of the other auction participant by the minimum bid increment. Automated bids are only entered on an auction participant's behalf in response to bids by other auction participants and not by a bid by that auction participant. Finally, if an automated bid is executed at a minimum bid threshold value and a bid is subsequently entered manually by another auction participant at exactly the same value, the manual bid shall govern. These and other aspects of the automated bidding feature of the present invention will become apparent from the examples illustrated in FIG. 8.

An auction participant may modify the specified minimum bid threshold after an automated bid has been executed and confirmed. However, notwithstanding the auction participant's ability to modify the minimum bid threshold, any automated bids submitted prior to such modification may not be withdrawn, rescinded or retracted.

Although a preferred embodiment of the present invention has been described in the foregoing Detailed Description and has been illustrated in the accompanying Figures, it will be understood that the invention is not limited to the embodiment disclosed but is capable of numerous modifications without departing from the scope of the invention claimed. Also, although the methods disclosed herein have been described and shown with reference to particular steps performed in a particular order, it will be understood that these steps may be combined, sub-divided or re-ordered to form an equivalent method without departing from the teachings of the present invention. Accordingly, unless specifically indicated herein, the order and grouping of the steps is not a limitation of the present invention.

What is claimed is:

1. A method for conducting online auctions, the method comprising:
providing for a secure area of a website, the secure area accessible only by prequalified users, the users accessing the secure area over a communication network from remote computers;
providing for the conduct of the auction in an opening round and a closing round, the auction based on competitive bidding by the users on a bid term relating to the sale of an auctioned product, the other commercial terms being preset;
providing for the receipt of bids from the users during the opening round, the opening round extending for a fixed period of time;
providing for the receipt of bids from the users during the closing round, the closing round commencing at the end of the opening round and continuing until the passage of a predefined period of time during which there have been no new confirmed bids; and
providing for the confirmation of a bid if the bid is lower than the previous confirmed bid by a multiple of a minimum bid increment, the winner of the auction having entered a confirmed bid during the opening round and submitting the lowest confirmed bid for the bid term during the closing round.

2. The method of claim 1 wherein the auctioned product is one or more parcels of copper concentrates.

3. The method of claim 1 wherein the bid term is the combined smelting and refining charge per pound of payable copper.

4. The method of claim 1 wherein the bid term is based on separated terms, the first term is the smelting charge per DMT of concentrates and the second term is the refining charge per pound of payable copper, the users entering bids for the first term and the second term calculated automatically based on the bids for the first term.

5. The method of claim 4 wherein the value of the second term is calculated to be equal to 1/1000 of the value of the first term.

6. The method of claim 1 further comprising providing for a public area of the website, the public area accessible by any visitor to the website, the public area posting information relating to the preset commercial terms applicable to the sale of the auctioned product subject to an auction.

7. The method of claim 1 wherein a user is permitted to participate in the closing round only if the user entered a confirmed bid during the opening round.

8. The method of claim 1 wherein a user may submit a bid manually using a bid entry component.

9. The method of claim 1 wherein a user may submit a bid automatically using an automated bid feature, the automated bid feature entering bids on behalf of a user down to a minimum bid threshold specified by the user.

10. A method for conducting online auctions, the method comprising:
providing for the conduct of an auction based on competitive bidding by users on a bid term relating to the sale of an auctioned product;
providing for the receipt of a manual bid entered by a user;
providing for the receipt of a minimum bid threshold from a user desiring to have bids entered automatically for the user by an automated bid feature, the automated bid feature entering a bid for a user if the minimum bid threshold for the user is lower than the previous confirmed bid by at least the minimum bid increment, the automated bid entered in an amount less than the previous confirmed bid by the minimum bid increment;
providing for the comparison of a previous confirmed bid to a bid entered manually or automatically; and
providing for the confirmation of a new bid if the bid is lower than the previous confirmed bid by a multiple of the minimum bid increment.

11. The method of claim 10 wherein the auctioned product is one or more parcels of copper concentrates.

12. The method of claim 10 wherein the bid term is the combined smelting and refining charge per pound of payable copper.

13. The method of claim 10 wherein the bid term is based on separated terms, the first term is the smelting charge per DMT of concentrates and the second term is the refining charge per pound of payable copper, the users entering bids for the first term and the second term calculated automatically based on the bids for the first term.

14. The method of claim 13 wherein the value of the second term is calculated to be equal to 1/1000 of the value of the first term.

15. The method of claim 10 further comprising providing for the rejection of a minimum bid threshold entered by a user if the minimum bid threshold is equal to a minimum bid threshold previously entered by another user.

16. The method of claim 10 further comprising providing for the submission of an automated bid in cases where more than one user has entered a minimum bid threshold, the automated bid entered for the user having the lower minimum bid threshold, the automated bid entered in an amount less than the previous confirmed bid by the minimum bid increment.

17. The method of claim 10 further comprising providing for the confirmation of a bid entered manually rather than an automated bid in cases where the amount of the manual bid is equal to the amount of a minimum bid threshold entered by a user.

18. A method for participating in online auctions, the method comprising:
accessing a secure area of a website for participating in an auction over a communication network, the auction having an opening round and a closing round, the auction based on competitive bidding on a bid term relating to the sale of an auctioned product, the other commercial terms being preset;
entering a bid relating to the bid term, the bid entered manually or by providing a minimum bid threshold to an automated bid feature of the website;
receiving a bid confirmation if the bid is confirmed, the bid confirmed if the bid is lower than the previous confirmed bid by a multiple of the minimum bid increment; and
winning the auction by entering a confirmed bid during the opening round and submitting the lowest confirmed bid during the closing round, the closing round commencing at the close of the opening round and continuing until the passage of a predefined period of time during which there is no user having submitted a manual bid or a minimum bid threshold to the automated bid feature that is lower that the previously confirmed bid by a multiple of the minimum bid increment.

19. The method of claim 18 wherein the auctioned product is one or more parcels of copper concentrates.

20. The method of claim 18 wherein the bid term is the combined smelting and refining charge per pound of payable copper.

21. The method of claim 18 wherein the bid term is based on separated terms, the first term is the smelting charge per DMT of concentrates and the second term is the refining charge per pound of payable copper, the users entering bids for the first term and the second term calculated automatically based on the bids for the first term.

22. The method of claim 21 wherein the value of the second term is calculated to be equal to 1/1000 of the value of the first term.

23. The method of claim 18 further comprising accessing a public area of the website, the public area posting information relating to the preset commercial terms applicable to the sale of the auctioned product subject to the auction.

24. The method of claim 18 further comprising receiving a notice that a minimum bid threshold submitted by a user has not been accepted by the automated bid feature if the minimum bid threshold is equal to a minimum bid threshold previously entered by another user.

25. The method of claim 18 further comprising receiving a bid confirmation if a bid is confirmed, the bid confirmed if the bid submitted is lower than the previous confirmed bid by a multiple of the minimum bid increment.

26. A method for participating in online auctions, the method comprising:
accessing a secure area of a website for participating in an auction over a communication network, the auction based on competitive bidding on a bid term relating to the sale of an auctioned product, the other commercial terms being preset;
entering a bid amount relating to the bid term, the bid entered manually or by providing a minimum bid threshold to an automated bid feature of the website, the automated bid feature entering a bid if the minimum bid threshold is lower than the previous confirmed bid by at least the minimum bid increment, the automated bid entered in an amount less than the previous confirmed bid by the minimum bid increment; and
receiving a bid confirmation if the bid submitted manually or by the automated bid feature is lower than the previous confirmed bid by a multiple of the minimum bid increment.

27. The method of claim 26 wherein the auctioned product is one or more parcels of copper concentrates.

28. The method of claim 26 wherein the bid term is the combined smelting and refining charge per pound of payable copper.

29. The method of claim 26 wherein the bid term is based on separated terms, the first term is the smelting charge per DMT of concentrates and the second term is the refining charge per pound of payable copper, the users entering bids for the first term and the second term calculated automatically based on the bids for the first term.

30. The method of claim 29 wherein the value of the second term is calculated to be equal to 1/1000 of the value of the first term.

31. The method of claim 26 further comprising accessing a public area of the website, the public area posting information relating to the preset commercial terms applicable to the sale of the auctioned product subject to the auction.

32. The method of claim 26 further comprising receiving a notice that a minimum bid threshold submitted by a user has not been accepted by the automated bid feature if the minimum bid threshold is equal to a minimum bid threshold previously entered by another user.

33. The method of claim 26 further comprising receiving a bid confirmation if a bid is confirmed, the bid confirmed if the bid submitted is lower than the previous confirmed bid by a multiple of the minimum bid increment.

34. A system for conducting online auctions, the system comprising:
means for conducting an auction using a website having an opening round and a closing round, the auction based on competitive bidding with respect to a bid term relating to the sale of an auctioned product, the other commercial terms being preset;
means for receiving bids from users submitted over a communications network;
means for confirming a bid if the bid is lower than the previous confirmed bid by a multiple of the minimum bid increment; and
means for determining the winner of the auction by comparing bids submitted either manually or using an automated bid feature, the winner submitting the lowest bid for the commercial term during the closing round, the closing round commencing at the close of the opening round and continuing until the passage of a predefined period of time during which no bid is confirmed.

35. The system of claim 34 wherein the auctioned product is one or more parcels of copper concentrates.

36. The system of claim 34 wherein the bid term is the combined smelting and refining charge per pound of payable copper.

37. The system of claim 34 wherein the bid term is based on separate terms, the first term is the smelting charge per DMT of concentrates and the second term is the refining charge per pound of payable copper, the users entering bids for the first term and the second term calculated automatically based on the bids for the first term.

38. The system of claim 37 wherein the value of the second term is calculated to be equal to 1/1000 of the value of the first term.

39. The system of claim 34 further comprising a bid entry component allowing users to submit bids manually.

40. The system of claim 34 wherein the automated bid feature enters bids on behalf of a user down to a minimum bid threshold entered by the user.

41. A computer useable medium and computer readable code embodied on the computer useable medium for conducting online auctions, the computer readable code comprising:
a first code segment providing for the conduct of an auction having an opening round and a closing round, the auction based on competitive bidding with respect to a bid term relating to the sale of an auctioned product, the other commercial terms being preset;
a second code segment providing for the receipt of bids from users during the opening round, the opening round extending for a fixed period of time, a bid being confirmed if the bid is lower than the previous confirmed bid by a multiple of the minimum bid increment; and
a third code segment providing for the receipt of bids from users during a closing round, the closing round commencing at the end of the opening round and continuing until the passage of a predefined period of time during which there have been no new confirmed bids, the winner of the auction submitting the lowest confirmed bid for the commercial term during the closing round.

42. The computer useable medium and computer readable code of claim 41 wherein the auctioned product is one or more parcels of copper concentrates.

43. The computer useable medium and computer readable code of claim 41 wherein the bid term is the combined smelting and refining charge per pound of payable copper.

44. The computer useable medium and computer readable code of claim 41 wherein the bid term is based on separate terms, the first term is the smelting charge per DMT of concentrates and the second term is the refining charge per pound of payable copper, the users entering bids for the first term and the second term calculated automatically based on the bids for the first term.

45. The computer useable medium and computer readable code of claim 44 wherein the value of the second term is calculated to be equal to 1/1000 of the value of the first term.
